(19) United States
(12) Patent Application Publication
(10) Pub. No.: US 2011/0065484 A1
(43) Pub. Date: Mar. 17, 2011

(54) WIRELESS MOBILE COMMUNICATION DEVICES, CHIPSETS, AND HANDS-FREE MODE CONTROLLING METHODS THEREOF

(75) Inventor: Xiaomei Liu, Zhejiang (CN)

(73) Assignee: VIA TELECOM, INC., San Diego, CA (US)

(21) Appl. No.: 12/623,477

(22) Filed: Nov. 23, 2009

(30) Foreign Application Priority Data
Sep. 16, 2009 (CN) 200910175128.0

(51) Int. Cl. H04M 1/00; G08B 21/00

(52) U.S. Cl. 455/569.2; 340/670

(57) ABSTRACT

A wireless mobile communication device is provided. The wireless mobile communication device has, a wireless communication module for performing wireless communications, a hands-free conversation module for providing a hands-free mode of a phone conversation during the wireless communications, a speed value generation module for receiving location or velocity information to generate a speed value, and a hands-free mode controller for determining whether the speed value has exceeded a predetermined threshold value, and activating the hands-free conversation module in response to the speed value exceeding the predetermined threshold value.

### CROSS REFERENCE TO RELATED APPLICATIONS

This application claims priority of China Patent Application No. 200910175128.0, filed on Sep. 16, 2009.

### BACKGROUND OF THE INVENTION

1. Field of the Invention

The invention generally relates to a wireless mobile communication device handling a hands-free mode during a phone conversation, and more particularly, to wireless mobile communication device, chipset, and hands-free mode controlling method thereof.

2. Description of the Related Art

With the advancement in wireless communication technologies, wireless mobile communication devices, such as mobile phones, smart-phones, and PDA (personal digital assistant) phones, have become indispensable to many in the developed world. Wireless mobile communication devices enable users' portability while on the move.

For conventional wireless mobile communication devices, users may hold a wireless mobile communication device close to their ear so as to listen to a voice during a conversation, i.e. a so-called hand-held mode. However, inconvenience occurs, when users do not have a hand to spare. To solve this problem, a hands-free mode is provided with most conventional wireless mobile communication devices, wherein speakers/microphones are used, so that no hands are required for conversation with a calling party.

Generally, the hands-free mode is activated by two methods. The first is for users to manually switch their wireless mobile communication devices from a hand-held mode to a hands-free mode via man-machine interfaces. The second is in response for a speaker/microphone set to be connected to the wireless mobile communication device and the wireless mobile communication device is switched to the hands-free mode. In order to maintain wireless characteristics for the second method, the connection between the speaker/microphone set and the wireless mobile communication device is preferably established by short-distance wireless technologies, such as Bluetooth, Ultra-Wide Band (UWB), Wireless Universal Serial Bus (Wireless USB) technology. In this case, a user must first configure, couple, or pair the wireless connection between the speaker/microphone and the wireless mobile communication device manually. Also, a user must configure a manual or automatic operation mode of the speaker/microphone. When a manual operation mode is configured, the “answer” button must be pushed to initiate a phone conversation in a hands-free mode. When an automatic operation mode is configured, incoming phone calls will be answered automatically after 1 to 3 phone rings, as preset by users. For wireless solutions, the second method requires additional speaker/microphone to be purchased and consumes additional power to transmit and/or receive voice signals from and to the speaker/microphone.

For both methods, manual configuration is required to activate or deactivate the hands-free mode, which is inconvenient for users. Thus, a wireless mobile communication device with automatic switching between a hand-held and hands-free mode is desired.

### BRIEF SUMMARY OF THE INVENTION

Accordingly, embodiments of the invention provide wireless mobile communication device, chipset, and hands-free mode controlling method thereof. In one aspect of the invention, a wireless mobile communication device is provided. The wireless mobile communication device comprises a wireless communication module, a hands-free conversation module, a speed value generation module, and a hands-free mode controller. The wireless communication module is for performing wireless communications. The hands-free conversation module is for providing a hands-free mode of a phone conversation during the wireless communications. The speed value generation module is for receiving location or velocity information to generate a speed value. The hands-free mode controller is for determining whether the speed value has exceeded a predetermined threshold value, and activating the hands-free conversation module in response to the speed value exceeding the predetermined threshold value.

In another aspect of the invention, a chipset for a wireless mobile communication device with a hands-free conversation module providing a hands-free mode of a phone conversation is provided. The chipset comprises a speed value generation module and a hands-free mode controller. The speed value generation module is for receiving location or velocity information to generate a speed value. The hands-free mode controller is for determining whether the speed value has exceeded a predetermined threshold value, and activating the hands-free conversation module in response to the speed value exceeding the predetermined threshold value.

In another aspect of the invention, a hands-free mode controlling method for a wireless mobile communication device with a hands-free conversation module providing a hands-free mode of a phone conversation is provided. The method comprises receiving location or velocity information of the wireless mobile communication device, generating a speed value according to the location or velocity information, determining whether the speed value has exceeded a predetermined threshold value, and activating the hands-free conversation module in response to the speed value exceeding the predetermined threshold value.

Other aspects and features of the invention will become apparent to those ordinarily skilled in the art upon review of the following descriptions of specific embodiments of an apparatus, system, and methods for handling hands-free conversation in a wireless communication network.

### BRIEF DESCRIPTION OF DRAWINGS

The invention can be more fully understood by reading the subsequent detailed description and examples with references made to the accompanying drawings, wherein:

FIG. 1 is a block diagram illustrating a wireless communication environment in accordance with an embodiment of the invention;

FIG. 2 is a block diagram illustrating a wireless mobile communication device in accordance with an embodiment of the invention;

FIG. 3 is a block diagram illustrating a chipset in accordance with an embodiment of the invention; and

FIG. 4 is a flow chart of a hands-free mode controlling method in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As stated previously, for conventional wireless mobile communication devices, manual configuration is required in both hands-free mode methods to activate or deactivate the hands-free mode, which is inconvenient and sometimes dangerous for users. For example, if a phone call arrives when the user is driving on the road, the user has to manually switch the configuration from the hand-held mode, as preset in this case, to the hands-free mode to proceed with the phone conversation. This often leads to traffic accidents. Therefore, the present invention provides a wireless mobile communication device with automatic switching between a hand-held and hands-free mode.

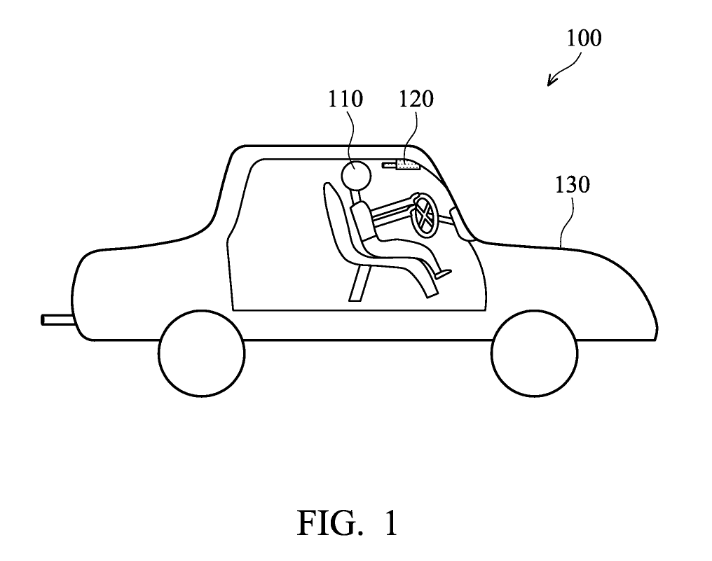

FIG. 1 is a block diagram illustrating a wireless communication environment in accordance with an embodiment of the invention. The wireless communication environment 100 includes a user 110, a wireless mobile communication device 120, and a vehicle 130. For those skilled in the art, the vehicle 130 is a vehicle providing transportation for a user 110, and is not limited to being a car. The wireless mobile communication device 120 first generates a speed value according to location or velocity information of itself, and then determines whether the speed value has exceeded a predetermined threshold value. If so, the wireless mobile communication device 120 automatically switches to the hands-free mode. Consequently, a user 110 is not required to manually switch the wireless mobile communication device 120 to the hands-free mode when driving. Also, a hands-free mode is not required to be manually configured in advance.

In another embodiment, if a user 110 is moving at a speed exceeding a predetermined threshold value when not traveling in a vehicle 130, the wireless mobile communication device 120 can also automatically switch to the hands-free mode as described above.

In other embodiments, a default setting of the wireless mobile communication device 120 may be a hand-held mode. When the wireless mobile communication device 120 detects that the speed value has exceeded a predetermined threshold value, the hand-held mode may be automatically switched to the hands-free mode. When the wireless mobile communication device 120 detects that the speed value has fallen below the predetermined threshold value, the hands-free mode may be automatically switched to the hand-held mode. Furthermore, when the hands-free mode is activated for a phone conversation and the speed value has fallen below the predetermined threshold value during the phone conversation, the hands-free mode remains activated and does not automatically switched to the hand-held mode during the phone conversation. In another embodiment, the wireless mobile communication device 120 may be set to turn off the function of detecting the speed value during a phone conversation, to save computing power thereof. The function of detecting the speed value may be turned on again when the phone conversation is completed. The predetermined threshold value may be set via a client interface of the wireless mobile communication device 120.

In some embodiments, the wireless communication environment 100 may further include a Bluetooth communications device (not shown) for providing a Bluetooth connection to the wireless mobile communication device 120. With Bluetooth connectivity, the wireless mobile communication device 120 can transmit/receive voice signals of a phone conversation to/from the Bluetooth communications device. The Bluetooth communications device may be implemented as a portable vehicle speaker or a wireless microphone/earphone. Although Bluetooth technology is used in this embodiment, other short-distance personal wireless communication technologies may be employed, as known by those skilled in the art, such as Wireless USB or UWB technology.

The wireless mobile communication device 120 may be further set to automatically answer all incoming phone calls when the hands-free mode is activated. Since the ambient noise caused by the vehicle 130 increases as the vehicle 130 speeds up, the wireless mobile communication device 120 may be set to adjust the volume of the phone conversation according to the speed value of the wireless mobile communication device 120. For example, as the speed value of the wireless mobile communication device 120 increases, the volume of a speaker is increased correspondingly. Also, generally, the background noise of a phone conversation increases as the vehicle 130 speeds up. Thus, as the speed value of the wireless mobile communication device 120 increases, the gain and signal-to-noise ratio of voice signals of the phone conversation, and microphone sensitivity may be also increased.

The location or velocity information may be obtained by a variety of methods, such as, via a satellite positioning system or an inertial navigation system. The satellite positioning system or inertial navigation system may be implemented as a functional module in the wireless mobile communication device 120, or a standalone device connected to the wireless mobile communication device 120. Alternatively, the location or velocity information may be received from a wireless communications network (not shown) by the wireless module of the wireless mobile communication device 120. Note that the wireless communications network includes an intelligent network providing location based services.

The satellite positioning system may include a Global Positioning System (GPS), a Global Navigation Satellite System (GLONASS), a Galileo Positioning System, or a Beidou Navigation System. The location based services provide location information of the wireless mobile communication device 120 by measuring the radio signals thereof received by the base stations.

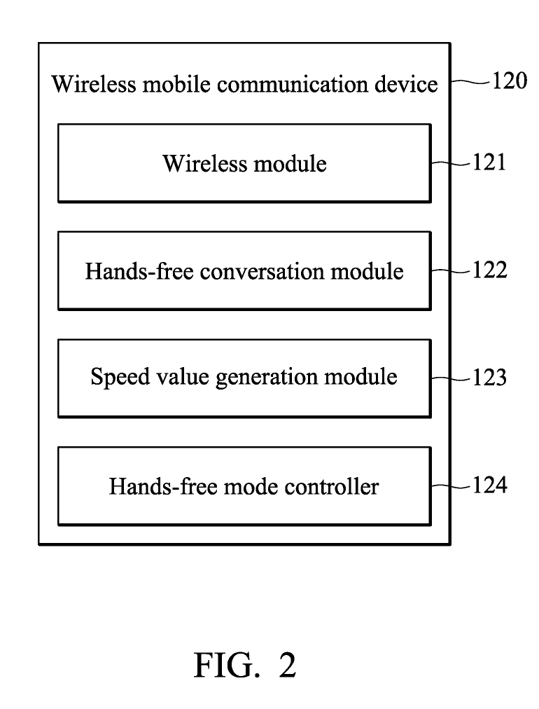

FIG. 2 is a block diagram illustrating a wireless mobile communication device in accordance with an embodiment of the invention. In addition to the wireless module 121 for performing wireless communications, the wireless mobile communication device 120 also includes a hands-free conversation module 122 for providing the hands-free mode of phone conversations during wireless communications. A speed value generation module 123 is also included to receive the location or velocity information of the wireless mobile communication device 120 and to generate a speed value. In one embodiment, the speed value generation module 123 may be set to skip the generation of the speed value of the wireless mobile communication device 120 and to directly receive the speed value from another functional unit, such as a positioning unit supporting a GPS, GLONASS, Galileo Positioning System, or Beidou Navigation System. The wireless mobile communication device 120 further includes a hands-free mode controller 124 for determining whether the speed value of the wireless mobile communication device 120 has exceeded the predetermined threshold value, and activating the hands-free conversation module 122 to switch to the hands-free mode in response to the speed value of the wireless mobile communication device 120 exceeding the predetermined threshold value.

In other embodiments, a hands-free mode default setting of the wireless mobile communication device 120 may be switched off. The hands-free mode is automatically activated when the hands-free mode controller 124 detects that the speed value of the wireless mobile communication device 120 has exceeded the predetermined threshold value. When the hands-free mode controller 124 detects that the speed value of the wireless mobile communication device 120 has fallen below the predetermined threshold value, the hands-free mode is switched off and the hand-held mode is activated. In some embodiments, the wireless mobile communication device 120 may further include a Bluetooth communications module (not shown) to transmit/receive the voice signals of a phone conversation to/from a Bluetooth communications device, such as a portable vehicle speaker or a wireless microphone, using Bluetooth technology.

Furthermore, the hands-free conversation module 122 remains activated when the hands-free mode controller 124 detects that the speed value of the wireless mobile communication device 120 has fallen below the predetermined threshold value during the phone conversation. The predetermined threshold value may be set via a client interface (not shown) of the wireless mobile communication device 120.

The wireless mobile communication device 120 may be further set to automatically answer all incoming phone calls when the hands-free conversation module 122 is activated. Alternatively, the wireless mobile communication device 120 may be set to answer the incoming phone calls according to the speech instructions from the user 110 received by a speech recognition module (not shown). Since the ambient noise caused by the vehicle 130 increases as the vehicle 130 speeds up, the hands-free conversation module 122, when activated, may be set to adjust the volume and microphone sensitivity of the phone conversations according to the speed value of the wireless mobile communication device 120 (i.e. the speed value of the vehicle 130 when the wireless mobile communication device 120 is placed in the vehicle 130, as shown in FIG. 1). For example, as the speed value of the vehicle 130 increases, the volume level of the phone conversation is increased. Also, generally, the background noise of the phone conversation increases as the vehicle 130 speeds up. Thus, as the speed value of the vehicle 130 increases, the gain and signal-to-noise ratio of voice signals of the phone conversation, and microphone sensitivity may also be increased.

The location or velocity information may be obtained by a variety of methods, such as, via a satellite positioning system or an inertial navigation system. The satellite positioning system or inertial navigation system may be implemented as a functional module (not shown) in the wireless mobile communication device 120, or a standalone device connecting to the wireless mobile communication device 120. Alternatively, the location or velocity information may be obtained from the location based services provided by an intelligent network in a wireless communications network (not shown), via the wireless module 121.

The satellite positioning system may include a GPS, a GLONASS, a Galileo Positioning System, or a Beidou Navigation System. The location based services provide the location information of the wireless mobile communication device 120 by measuring the radio signals thereof received by the base stations.

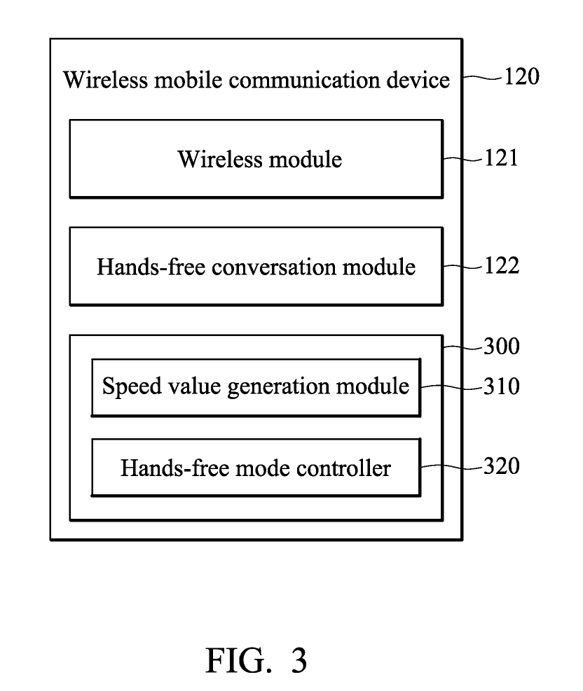

FIG. 3 is a block diagram illustrating a chipset in accordance with an embodiment of the invention. The chipset 300 can be used in any wireless mobile communication device providing a hands-free mode of phone conversations, such as the wireless mobile communication device 120. The chipset 300 includes a speed value generation module 310 for receiving the location or velocity information of the wireless mobile communication device 120 and for generating a speed value. In one embodiment, the speed value generation module 310 may be set to directly receive the speed value of the wireless mobile communication device 120 without the generation step. The chipset 300 also includes a hands-free mode controller 320 for determining whether the speed value of the wireless mobile communication device 120 has exceeded a predetermined threshold value, and for activating the hands-free conversation module 122 to the hands-free mode in response to the speed value of the wireless mobile communication device 120 exceeding the predetermined threshold value. The hands-free mode controller 320 may further determine whether the speed value of the wireless mobile communication device 120 has fallen below the predetermined threshold value, and deactivate the hands-free conversation module 122 and switch back to the hand-held mode in response to the speed value falling below the predetermined threshold value.

In other embodiments, a hands-free mode default setting of the wireless mobile communication device 120 may be switched off. The hands-free mode is automatically activated when the hands-free mode controller 320 detects that the speed value of the wireless mobile communication device 120 has exceeded the predetermined threshold value. When the hands-free mode controller 320 detects that the speed value of the wireless mobile communication device 120 has fallen below the predetermined threshold value, the hands-free mode is switched off and the hand-held mode is activated. In some embodiments, the chipset 300 may further include a Bluetooth communications module (not shown) to transmit/receive the voice signals of a phone conversation to/from a Bluetooth communications device, such as a portable vehicle speaker or a wireless earphone, using Bluetooth technology.

Furthermore, the hands-free conversation module 122 remains activated when the hands-free conversation module 122 is activated for a phone conversation and the hands-free mode controller 320 detects that the speed value of the wireless mobile communication device 120 has fallen below the predetermined threshold value. The predetermined threshold value may be set via a client interface (not shown) of the chipset 300.

The chipset 300 may be further set to automatically answer all incoming phone calls when the hands-free conversation module 122 is activated. Alternatively, the chipset 300 may be set to answer the incoming phone calls according to the speech instructions from the user 110 received by a speech recognition module (not shown). Since the ambient noise caused by the vehicle 130 increases as the vehicle 130 speeds up, the hands-free conversation module 122, when activated, may be set to adjust the volume of the phone conversations according to the speed value of the wireless mobile communication device 120 (i.e. the speed value of the vehicle 130 when the wireless mobile communication device 120 is placed in the vehicle 130, as shown in FIG. 1). For example, as the speed value of the vehicle 130 increases, the volume level of the phone conversation is increased. Also, generally, the background noise of the phone conversation increases as the vehicle 130 speeds up. Thus, as the speed value of the vehicle 130 increases, the gain and the signal-to-noise ratio of voice signals of the phone conversation may also increase.

The location or velocity information may be obtained by a variety of methods, such as, via a satellite positioning system or an inertial navigation system. The satellite positioning system or inertial navigation system may be implemented as a functional module (not shown) in the chipset 300 or the wireless mobile communication device 120, or a standalone device connecting to the wireless mobile communication device 120. Alternatively, the location or velocity information may be obtained from the location based services provided by an intelligent network in a wireless communications network (not shown), via the wireless module 121.

The satellite positioning system may include a GPS, a GLONASS, a Galileo Positioning System, or a Beidou Navigation System. The location based services provide the location information of the wireless mobile communication device 120 by measuring the radio signals thereof received by the base stations.

In one embodiment, the chipset 300 includes a processor (not shown), such as an ARM processor or a RISC (Reduced Instruction Set Computer) processor. In one embodiment, the processor executes a real-time operating system and applications therein. The speed value generation module 310 and the hands-free mode controller 320 may be implemented by any combination of hardware and software which is executable by the processor.

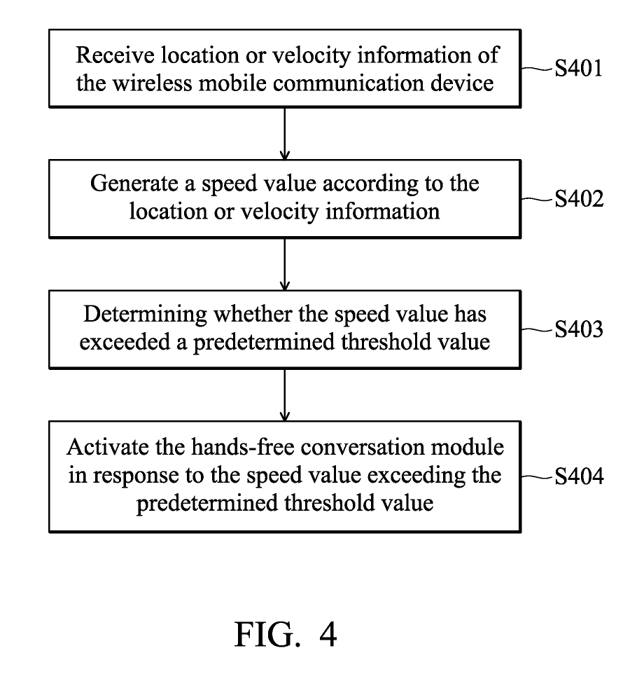

FIG. 4 is a flow chart of a hands-free mode controlling method in accordance with an embodiment of the invention. The method may be applied to any wireless mobile communication device providing a hands-free mode of phone conversations, such as the wireless mobile communication device 120 with the hands-free conversation module 122. The hands-free conversation module 122 provides a hands-free mode. The method begins by receiving location or velocity information of the wireless mobile communication device 120 (step S401). The wireless mobile communication device 120 then generates a speed value of itself according to the location or velocity information (step S402). Accordingly, the wireless mobile communication device 120 determines whether the speed value has exceeded a predetermined threshold value (step S403), and activates the hands-free conversation module 122 to the hands-free mode in response to the speed value exceeding the predetermined threshold value (step S404). In one embodiment, to avoid frequent switching between the hand-held mode and the hands-free mode, the frequency for performing generation of the speed value in the step S402 may be adjusted according to factors, such as time or power level, and the computing capability of the wireless mobile communication device 120, etc. For example, if the frequency for performing the step S401 is 30 times per second, then the frequency of performing the step S402 may be set to be 1 time per second. It is noted that the frequency for performing the steps S401 and S402 are not necessarily the same.

In other embodiments, the hands-free mode controlling method may further deactivate the hands-free conversation module 122 before the step S401, so that the user 110 may proceed with phone conversations in the hand-held mode when the speed value of the wireless mobile communication device 120 is less than the predetermined threshold value. The hands-free conversation module 122 is automatically activated when the hands-free mode controller 124 detects that the speed value of the wireless mobile communication device 120 has exceeded the predetermined threshold value. In some embodiments, the wireless mobile communication device 120 may further include a Bluetooth communications module (not shown) to transmit/receive the voice signals of the phone conversations to/from a Bluetooth communications device, such as a portable vehicle speaker or a wireless earphone, using Bluetooth technology.

Furthermore, the hands-free mode controlling method may leave the hands-free conversation module 122 activated when the hands-free conversation module 122 is activated for a phone conversation and the speed value of the wireless mobile communication device 120 has fallen below the predetermined threshold value. The predetermined threshold value may be set via a client interface (not shown) of the wireless mobile communication device 120.

The hands-free mode controlling method may set the wireless mobile communication device 120 to automatically answer all incoming phone calls when the hands-free conversation module 122 is activated. Alternatively, the hands-free mode controlling method may set the wireless mobile communication device 120 to answer the incoming phone calls according to the speech instructions from the user 110 received by a speech recognition module (not shown). Since the ambient noise caused by the vehicle 130 increases as the vehicle 130 speeds up, the hands-free conversation module 122, when activated, may be set to adjust the volume of the phone conversations according to the speed value of the wireless mobile communication device 120 (i.e. the speed value of the vehicle 130 when the wireless mobile communication device 120 is placed in the vehicle 130, as shown in FIG. 1). For example, as the speed value of the vehicle 130 increases, the volume level of the phone conversation is increased. Also, generally, the background noise of the phone conversation increases as a vehicle 130 speeds up. Thus, as the speed value of the vehicle 130 increases, the gain and signal-to-noise ratio of voice signals of the phone conversation, and microphone sensitivity may also increase.

The location or velocity information may be obtained by a variety of methods, such as, via a satellite positioning system or an inertial navigation system. The satellite positioning system or inertial navigation system may be implemented as a functional module (not shown) in the wireless mobile communication device 120, or a standalone device connecting to the wireless mobile communication device 120. Alternatively, the location or velocity information may be obtained from the location based services provided by an intelligent network in a wireless communications network (not shown), via the wireless module 121.

The satellite positioning system may include a GPS, a GLONASS, a Galileo Positioning System, or a Beidou Navigation System. The location based services provide the location information of the wireless mobile communication device 120 by measuring the radio signals thereof received by the base stations.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A wireless mobile communication device, comprising:
a wireless communication module for performing wireless communications;
a hands-free conversation module for providing a hands-free mode of a phone conversation;
a speed value generation module for receiving location or velocity information to generate a speed value; and
a hands-free mode controller for determining whether the speed value has exceeded a threshold value, and for activating the hands-free conversation module in response to the speed value exceeding the predetermined threshold value.

2. The wireless mobile communication device of claim 1, wherein incoming phone calls are automatically answered if the hands-free conversation module is activated.

3. The wireless mobile communication device of claim 1, wherein the hands-free mode controller further adjusts a volume level of the phone conversation according to the speed value.

4. The wireless mobile communication device of claim 1, wherein the hands-free conversation module remains activated in response to the speed value falling below the predetermined threshold value during the phone conversation.

5. The wireless mobile communication device of claim 1, further comprising a client interface for setting the predetermined threshold value.

6. The wireless mobile communication device of claim 1, further comprising a satellite positioning module for generating the location or velocity information.

7. The wireless mobile communication device of claim 1, further comprising an inertial navigation module for generating the location or velocity information.

8. The wireless mobile communication device of claim 1, wherein the wireless communication module further receives the location or velocity information from a wireless communications network.

9. A chipset for a wireless mobile communication device, wherein the wireless mobile communication device having a hands-free conversation module providing a hands-free mode of a phone conversation, the chipset comprising:
a speed value generation module for receiving location or velocity information to generate a speed value; and
a hands-free mode controller for determining whether the speed value has exceeded a predetermined threshold value, and for activating the hands-free conversation module in response to the speed value exceeding the predetermined threshold value.

10. The chipset of claim 9, wherein incoming phone calls are automatically answered if the hands-free conversation module is activated.

11. The chipset of claim 9, wherein the hands-free mode controller further adjusts a volume level of the phone conversation according to the speed value.

12. The chipset of claim 9, wherein the hands-free conversation module remains activated in response to the speed value falling below the predetermined threshold value during the phone conversation.

13. The chipset of claim 9, further comprising a satellite positioning module for generating the location or velocity information.

14. The chipset of claim 9, further comprising an inertial navigation module for generating the location or velocity information.

15. The chipset of claim 9, further comprising a wireless communication module for receiving the location or velocity information from a wireless communications network.

16. A hands-free mode controlling method for a wireless mobile communication device with a hands-free conversation module providing a hands-free mode of a phone conversation, comprising:
receiving location or velocity information of the wireless mobile communication device;
generating a speed value according to the location or velocity information;
determining whether the speed value has exceeded a predetermined threshold value; and
activating the hands-free conversation module in response to the speed value exceeding the predetermined threshold value.

17. The hands-free mode controlling method of claim 16, further comprising automatically answering incoming phone calls if the hands-free conversation module is activated.

18. The hands-free mode controlling method of claim 16, further comprising adjusting, by the hands-free conversation module, a volume level of the phone conversation according to the speed value.

19. The hands-free mode controlling method of claim 16, further comprising continuing activation of the hands-free conversation module in response to the speed value falling below the predetermined threshold value during the phone conversation.

20. The hands-free mode controlling method of claim 16, wherein the location or velocity information is generated by one of the followings:
a satellite positioning module of the wireless mobile communication device;
an inertial navigation module of the wireless mobile communication device; and
a wireless communications network connected with the wireless mobile communication device.
